(19) United States
(12) Patent Application Publication
(10) Pub. No.: US 2014/0164440 A1
(43) Pub. Date: Jun. 12, 2014

(54) APPARATUS AND METHOD FOR SHARED DATABASE ENVIRONMENT TO PROVIDE ACCESS TO DATABASES ON A SHARED INFRASTRUCTURE

(71) Applicants: XEROUND SYSTEMS LTD., Yahud (IL); XEROND INC., Mountain View, CA (US)

(72) Inventors: Avi VIGDER, Savyon (IL); Gilat Antebi, Givataim (IL); Ilan Bronshtein, Rishon-LeZion (IL); Itai Gal, Tel-Aviv (IL)

(73) Assignees: Xeround Inc., Mountain View, CA (US); Xeround Systems Ltd., Yahud (IL)

(21) Appl. No.: 13/710,583

(22) Filed: Dec. 11, 2012

(51) Int. Cl. G06F 17/30

(52) U.S. Cl. CPC G06F 17/30283
USPC 707/803

(57) ABSTRACT

A database system includes a back end and a front end. The back end contains data storage and a database engine, and the front end contains front end units, each of which allows an application developer to support a database user application requiring data storage. The application developer gets its own instance where it may define the content and format of data storage required by the application, and the front end units are connected to share the back end for common storage of their respective application data so that the developer does not have to provide the actual data storage. The system is useful for cloud-based computing paradigms.

### FIELD AND BACKGROUND OF THE INVENTION

The present invention, in some embodiments thereof, relates to apparatus and a method for a shared database environment to provide access to many databases on a shared infrastructure. More particularly, but not exclusively, the present embodiments provide database facilities to multiple users connected by a network, allowing any application developers on the network to be able to access database instances from their applications.

To date, traditional databases are installed on a single host, which may be either physical or virtual, and each database serves one or more applications sharing the same data. In order to provide large number of database instances for large numbers of applications, there are three options:
1) multiple hosts,
2) installing multiple instances on the same host or
3) sharing one database among multiple users.
Each of the above approaches has its benefits and drawbacks.
Multiple hosts—very large overhead and inefficiency in utilizing resources which yields very high cost, especially if considering an increasingly large number of relatively small database instances, of which most are idle most of the time.
Multiple instances on the same host
   Each instance has its own overhead regardless of the use.
   As each database instance writes and reads on its own—severe I/O bottlenecks can emerge whenever large numbers of instances reach peaks of data access at the same time.
   There is no way to relieve the pressure or shift resources to handle peaks.
Multiple instances sharing the same database
   Usually not all functionality is supported by all the instances—as it is not the same product. Instead, a user/connection within the product typically enforces various limitations.
   Multiple instances that peak simultaneously can cause degradation in performance for each other. They lack ability to relieve the pressure online while continuing to serve all the database instances.

Solutions that do tackle multi-tenancy usually provide the solution at the application level. The solution is to provide mechanisms in the DB layer to enable the application to support multiple tenancy. However in this case the application is the same and each instance is a different end user making use of the same application. Such a solution is not helpful in a cloud-based context, where database facilities may be required for multiple applications, so that solutions at the application level have to be repeated for each application.

### SUMMARY OF THE INVENTION

The present embodiments provide a solution to the cloud-based context, in that they provide a database system that is suitable for different applications, each application having its own set of end users. Each application becomes a separate tenant of an overall database, and the application is left to manage its own end users.

A way in which this may be achieved is to provide separate front and back ends for the database system. The back end is a large database and multiple front ends support applications and allow the different applications to store their data in the back end. The application writer has access to the front end to define his application, including the format and nature of the data to be stored, and the front end then communicates with the back end to manage the data storage.

According to an aspect of some embodiments of the present invention there is provided a database application system comprising:

a back end, the back end comprising data storage and engine;
a plurality of front end units, said front end units configured to support database user applications requiring data storage, the content and format of the data to be stored being defined by the respective database user application, wherein the plurality of front end units are connected to share said back end for common storage of their respective application-defined data.

In an embodiment, said back end is distributed over a plurality of nodes on a network.

In an embodiment, said back end is comprised in a cluster of servers.

In an embodiment, said back end is dynamically scalable.

In an embodiment, said respective front end units are distributed over a plurality of nodes on a network.

In an embodiment, each user application has a plurality of end users.

In an embodiment, each one of said plurality of end-users has respective data, such that said back end stores data per end-user per application.

In an embodiment, each one of said front ends provides a separate database instance, said front ends being configured to select data belonging to a respective database application from said shared database.

In an embodiment, each database application is configured to select from said data belonging thereto and provided by said front end, data pertaining to respective end users.

In an embodiment, each front end is configured to indicate its own data stored in the backend with a respectively unique markup.

In an embodiment, the solution may be deployed as a cloud-based database solution for said database user applications.

In an embodiment, said front end is provided as a driver to client devices.

In an embodiment, the front end is an SQL front end.

In an embodiment, the front end is a non SQL front end or an LDAP front end or an XML front end or a No-SQL front end.

According to a second aspect of the present invention there is provided a database application method on an electronic network, comprising:

providing a plurality of front end units;

at each of said front end units supporting a database application requiring data storage,

at said front end units allowing defining of content and format of application data to be stored by said database application;

connecting a database back-end commonly to each of said front end units; and

retrievably storing respective application data from each of said front end units in said common database back end.

An embodiment may comprise distributing said back end dynamically over a plurality of nodes on a network.

An embodiment may comprise distributing said back end over a cluster of servers.

An embodiment may comprise dynamically scaling said back end.

An embodiment may comprise distributing said respective front end units over a plurality of nodes on a network.

In an embodiment, each one of said plurality of applications has a plurality of end-users, each end user having respective data, and said back end stores data per end-user per application.

An embodiment may comprise providing a separate database instance via each one of said front ends for each database application, said front ends selecting data belonging to a respective database application from said shared database.

An embodiment may comprise selecting, at each database application, from said data belonging to said respective database application and provided by said front end, data pertaining to respective end users.

An embodiment may comprise providing from each front end, a respectively unique markup, to identify corresponding data stored in said backend.

The method may be deployed as a cloud-based database solution for said database user applications.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. The data processor may include a volatile memory for storing instructions and/or data and/or a non-volatile storage, for example, a magnetic hard-disk, flash memory and/or removable media, for storing instructions and/or data. A network connection may be provided and a display and/or a user input device such as a keyboard or mouse may be available as necessary.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram showing a database system according to the present embodiments and illustrating developer access to the front end units;

FIG. 2 is a simplified flow chart illustrating operation of the system of FIG. 1

FIG. 3 is a simplified diagram illustrating an embodiment of the present invention in which a single application uses two front ends;

FIG. 4 is a simplified diagram illustrating an embodiment of the present invention in which a single front end supports multiple database instances and thus multiple applications; and

FIG. 5 is a simplified diagram showing an embodiment of the present invention in which the front ends are implemented in client drivers or client machines.

### DESCRIPTION OF SPECIFIC EMBODIMENTS OF THE INVENTION

The present invention, in some embodiments thereof, relates to apparatus and a method for a shared database environment to provide access to many databases on a shared infrastructure. A database system includes a back end and a front end. The back end contains data storage and a database engine, and the front end contains front end units, each of which allows an application developer to support a database user application requiring data storage. The application developer may define the content and format of data storage required by the application, and the front end units are connected to share the back end for common storage of their respective application data so that the developer does not have to provide the actual data storage. The system is useful for cloud-based computing paradigms.

The system may offer a single type of Front-end to the system (of a certain access technology SQL/LDAP etc) or different types of frontends.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

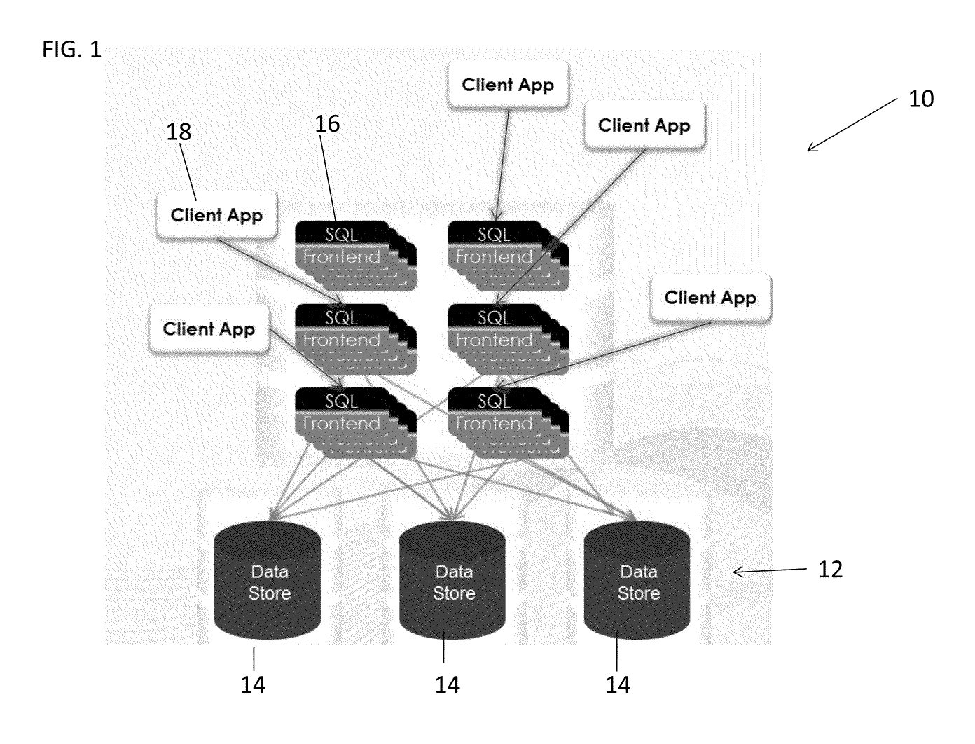

Referring now to the drawings, FIG. 1 is a simplified block diagram illustrating a database system 10 according to the present embodiments. The system includes a back end 12 which comprises the data storage facilities 14, in other words the database, and associated database engine. The data stores together form one large system database which is shared.

The system further consists of any number of front end units 16. The front end units provide a database management system, and anyone who wishes can use the front ends 16 to support their own applications 18, thus providing their applications 18 with database facilities. The users of the front end units are referred to hereinafter as database application users or database application developers, and are not to be confused with the end users who make use of the applications.

Thus a database application developer may use the available front ends 16 to implement an application 18 of his or her own, for their own end users, that needs a database. The database applications 18 may define their own database requirements, in terms of what data to store, how to store it, formatting, associating particular stored data with particular end users, and any other data storage issues. The content and format of the data storage are hence defined separately by the different database user applications, so that each application stores different data using different formats and different requirements. Nevertheless, the different front end units 16 are connected to share the system's back end 12 for common storage of their application-defined data. The back end 12 stores all the data provided by the different front ends 16. The front ends 16 firstly supply the back end with the data and the storage configurations and formats obtained from the applications 18, and then secondly the front ends 16 make sure that the correct application 18 receives its own application specific data.

The back end 12 may be provided on a single server, or on a cluster of servers, or may be distributed over nodes on a network. Again, the nodes may themselves be single servers or clusters of servers, depending on the storage requirements.

In order to accommodate changing storage requirements, the back end may be designed to be dynamically scalable. Such scalability may be achieved by various techniques, including having a very large logical storage space, to which physical storage may be added as needed.

The various front end units 16 may also be distributed over nodes on a network, or could all be provided on a single server or cluster of servers, as convenient. Each user application may be served by one or more Front-ends depending on the application needs.

Another embodiment can collocate Frontends with the user application.

Each database application may typically have several end users, or even unlimited numbers of end users. Indeed there are applications with database requirements that have millions of end users and numbers that keep growing, and the present embodiments are provided with such challenges in mind. Indeed, each one of the unlimited numbers of end-users may have his own data, so that the back end stores data for each end-user for each application. In such cases the front ends ensure that the database applications have access to their own data. In many cases, the applications themselves would have the responsibility to provide the correct data to the correct users.

Thus, in effect, one or more front ends provide a separate database instance, by selecting the data belonging to its corresponding database application from the shared database of the back end.

The database system may be deployed as a cloud-based database solution for different entities over the Internet to provide database supported applications. That is to say, application developers are able to design their own applications and to configure their applications to work with the present database system, without them having to be concerned about where or how the actual data is stored. For the developers, the database simply exists in the cloud.

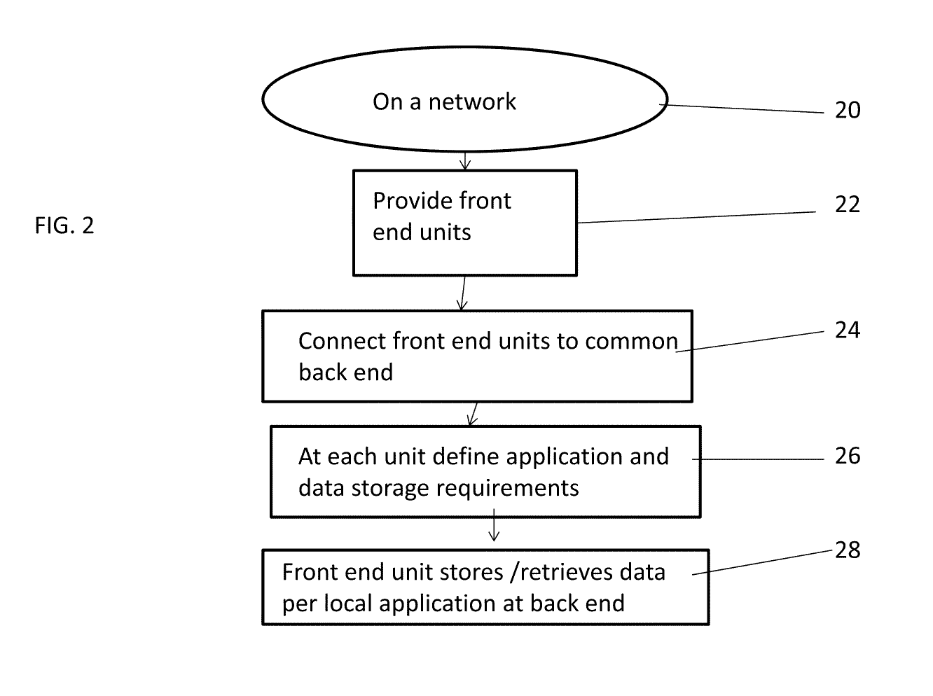

Reference is now made to FIG. 2, which is a simplified flow chart illustrating the deployment and operation of a system such as that illustrated in FIG. 1.

In box 20 a network such as the Internet is used as the basis for allowing the various components to inter-connect as needed. In box 22, front end units are provided for the various developers, and in box 24, the various front ends are connected to a common back end which provides database facilities such as data storage and data engine services.

In box 26 the developers are able to develop their applications using the front end units and define the data storage requirements of the application. The data storage requirements may be defined in terms of format, of schema, of content, of data fields, may include information to indicate to which end user it pertains etc. However the developer does not have to provide or manage the database. In box 28 the front end unit, or units that comprise a single database instance, retrievably stores data in the back end according to the application definitions. Markup labeling may be used to identify the data to the particular front end for retrieval purposes.

Considered now in greater detail, a solution according to the present embodiments may involve a shared backend system and a dedicated or shared frontend.

The shared backend may store data for multiple instances, meaning here multiple applications, each supported by a separate front end, while each data element is tagged by a unique identifier (XSID) and belongs to a single instance. The present embodiments may implement a backend by utilizing current system, as described in applicant's co-pending U.S. Pat. No. 7,644,087 and corresponding International Patent Application Publication No. WO2006/090367, which is scalable and fault tolerant. During system peaks caused either by large numbers of instances or by high demands from some of the instances, the backend can scale on more hosts to provide more compute and storage power. Such scaling of the backend may overcome most multi-tenancy issues that relate to online peaks, without the need to stop live databases and reshuffle them to different resources.

In general the backend can be any kind of a database solution, for example noSQL, to serve the required frontends.

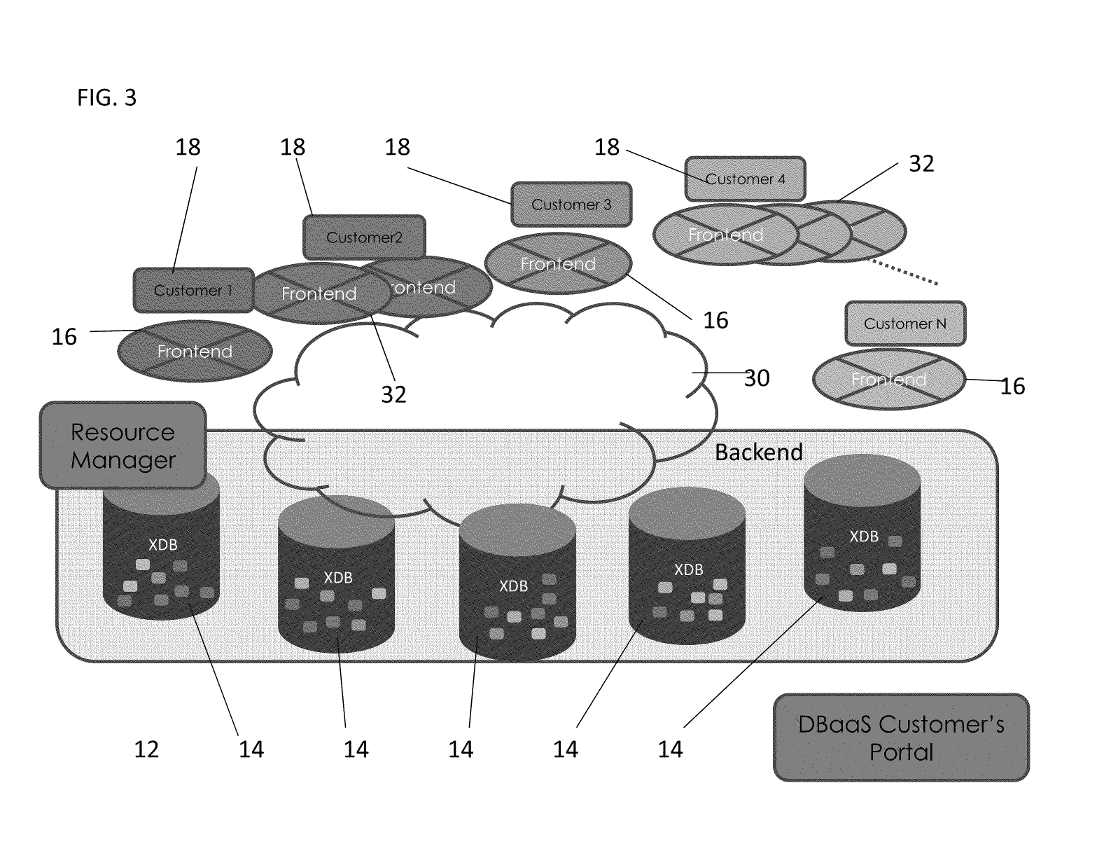

Reference is now made to FIG. 3, which is a simplified diagram illustrating an embodiment in which a single application uses multiple dedicated front ends. Features referred to in earlier figures are given the same reference numerals and are not explained again except as necessary for an understanding of the present embodiment. As explained, an embodiment may comprise a dedicated frontend, such as front ends 16 directed to applications 18 of customers 1, 3 and n, or dedicated multiple frontends 32, for each database instance for customers 2 and 4, and those frontends may typically access only the data whose XSID indicates that it is relevant to that application. As shown, the customer 2 application has two front ends and the customer 4 application has three front ends, but any number may be selected as needed depending on the database support demands of the application. Multiple front ends may be provided to a single user for scalability, for example for applications that require resources which are beyond the capabilities of a single front end. For example a particular application may require a large number of connections to end users, or may require a large amount of computing.

As shown, the multiple front ends are connected via cloud 30 to the backend 12, which includes data stores 14.

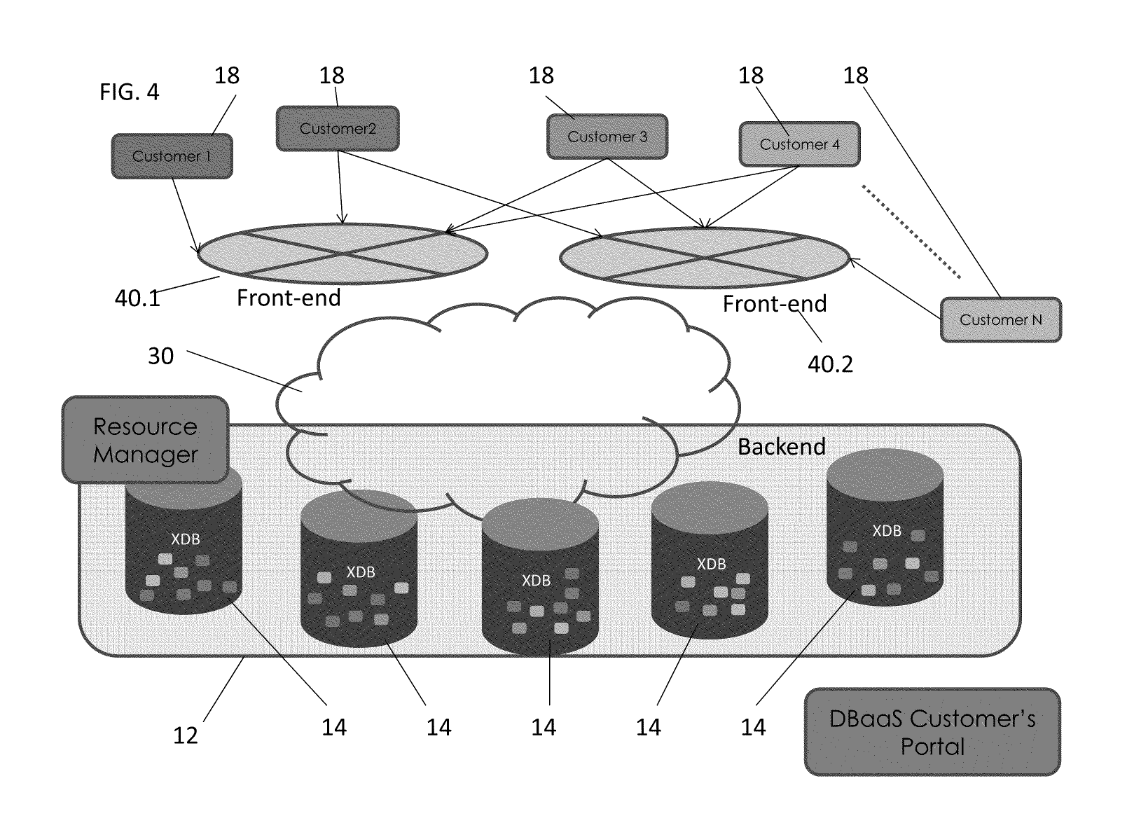

Reference is now made to FIG. 4, which is a simplified diagram illustrating a further embodiment in which a single front end supports several database instances and thus may support several applications. Features referred to in earlier figures are given the same reference numerals and are not explained again except as necessary for an understanding of the present embodiment. Such an embodiment may comprise one to one dedicated front ends as before and not shown again, and, in addition, one or more shared frontends 40.1, 40.2, where one frontend serves several instances, reducing the overhead even more. Thus, as illustrated customers 1, 2 and 3 are supported by the first front end 40.1, and customers 2, 3 and 4 . . . N are supported by the second front end 40.2. As shown, the multiple front ends are connected via cloud 30 to the backend 12, which includes data stores 14.

A single front end being shared between multiple users may be provided as a resource optimization.

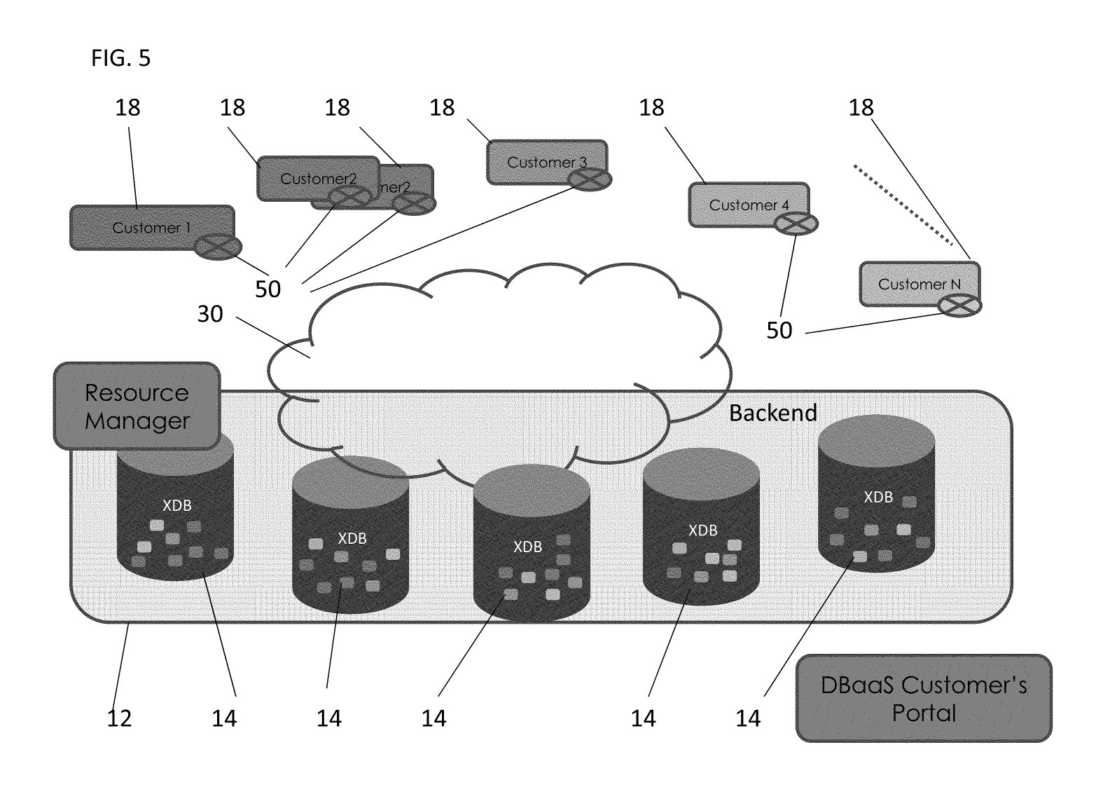

Reference is now made to FIG. 5 which illustrates a further embodiment of the invention in which the frontend is incorporated into a client driver and/or client machines. Features referred to in earlier figures are given the same reference numerals and are not explained again except as necessary for an understanding of the present embodiment. As shown, each customer application 18 has an incorporated front end 50, which may be included on the customer client machine running the application. The front end may be included as part of a driver program, or in the form of a virtual machine (VM) or in any other suitable way. As above, the multiple front ends are connected via cloud 30 to the backend 12, which includes data stores 14.

The present embodiments may reduce costs by serving all the instances using a single backend, thus saving the overhead for each instance. Such a solution contrasts with other solutions where a virtual machine (VM) or host needs to be allocated.

The functionality provided by the frontend remains complete as the frontend is not aware of the other instances hosted on the backend. This contrasts with some solutions where one instance is shared by multiple users so that each user is provided with a reduced part of the solution.

It is expected that during the life of a patent maturing from this application many relevant data storage and database technologies will be developed and the scope of the corresponding terms in the present description are intended to include all such new technologies a priori.

The terms “comprises”, “comprising”, “includes”, “including”, “having” and their conjugates mean “including but not limited to”.

The term “consisting of” means” “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A database application system comprising:
a back end, the back end comprising data storage and engine;
a plurality of front end units, said front end units configured to support database user applications requiring data storage, the content and format of the data to be stored being defined by the respective database user application, wherein the plurality of front end units are connected to share said back end for common storage of their respective application-defined data.

2. The database application system of claim 1, wherein said back end is distributed over a plurality of nodes on a network.

3. The database application system of claim 1, wherein said back end is comprised in a cluster of servers.

4. The database application system of claim 1, wherein said back end is dynamically scalable.

5. The database application system of claim 1, wherein said respective front end units are distributed over a plurality of nodes on a network.

6. The database application system of claim 1, wherein each user application has a plurality of end users.

7. The database application system of claim 5, wherein each one of said plurality of end-users has respective data, such that said back end stores data per end-user per application.

8. The database application system of claim 1, wherein each one of said front ends provides a separate database instance, said front ends being configured to select data belonging to a respective database application from said shared database.

9. The database application system of claim 8, wherein each database application is configured to select from said data belonging thereto and provided by said front end, data pertaining to respective end users.

10. The database application system of claim 8, wherein each front end is configured to indicate its own data stored in the backend with a respectively unique markup.

11. The database application system of claim 1, deployed as a cloud-based database solution for said database user applications.

12. The database application system of claim 1, wherein said front end is provided as a driver to client devices.

13. The database application system of claim 1, wherein the front end is an SQL front end.

14. The database application system of claim 1, wherein the front end is a non SQL front end or an LDAP front end or an XML front end or a No-SQL front end.

15. A database application method on an electronic network, comprising:
providing a plurality of front end units;
at each of said front end units supporting a database application requiring data storage,
at said front end units allowing defining of content and format of application data to be stored by said database application;
connecting a database back-end commonly to each of said front end units; and
retrievably storing respective application data from each of said front end units in said common database back end.

16. The database application method of claim 15, comprising distributing said back end dynamically over a plurality of nodes on a network.

17. The database application method of claim 15, comprising distributing said back end over a cluster of servers.

18. The database application method of claim 15, comprising dynamically scaling said back end.

19. The database application method of claim 15, comprising distributing said respective front end units over a plurality of nodes on a network.

20. The database application method of claim 15, wherein each one of said plurality of applications has a plurality of end-users, each end user having respective data, and said back end stores data per end-user per application.

21. The database application method of claim 15, comprising providing a separate database instance via each one of said front ends for each database application, said front ends selecting data belonging to a respective database application from said shared database.

22. The database application method of claim 21, comprising selecting, at each database application, from said data belonging to said respective database application and provided by said front end, data pertaining to respective end users.

23. The database application method of claim 21, comprising providing from each front end, a respectively unique markup, to identify corresponding data stored in said backend.

24. The database application method of claim 15, deployed as a cloud-based database solution for said database user applications.
